(19) United States
(12) Patent Application Publication
(10) Pub. No.: US 2008/0203723 A1
(43) Pub. Date: Aug. 28, 2008

(54) DETACHABLE PIPE JOINT AND JOINING METHOD

(75) Inventor: Raymond E. Cellemme, Matthews, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: CONBRACO INDUSTRIES, INC., Pageland, SC (US)

(21) Appl. No.: 11/677,641

(22) Filed: Feb. 22, 2007

(51) Int. Cl. F16L 37/00; B21D 39/04

(52) U.S. Cl. 285/39; 285/343; 29/428

(57) ABSTRACT

A detachable pipe joint and a method of joining a pipe to a valve, coupling, fitting or the like without requiring a special tool is capable of withstanding the higher fluid pressure typically generated within a larger diameter pipe. The pipe joint includes a retainer body defining a passageway for receiving a pipe, a retainer nut defining a through passageway coaxial with the passageway of the retainer body and the pipe, and a retaining ring positioned within an open end of the retainer body between the retainer body and the pipe. Securing means on the retainer nut engage securing means on the retainer body to compress the retaining ring in a radial direction when the retainer nut is advanced in an axial direction towards the retainer body. The retaining ring has at least one, and preferably a plurality, of inwardly extending projections to retain the pipe within the pipe joint.

### TECHNICAL FIELD AND BACKGROUND OF THE INVENTION

This invention relates to pipe joints and to methods of joining pipe to valves, couplings, fittings and the like. More particularly, the invention is a detachable pipe joint that does not require a special tool to form the joint and that is capable of withstanding the higher fluid pressure typically generated within a larger diameter pipe.

Pipe joints are commonly made by welding, brazing or soldering a pipe to a valve, coupling, fitting or the like. Welding, brazing and soldering, however, require special equipment and acquired skill. In addition, the high temperatures generated by welding, brazing and soldering operations can damage or weaken the pipe, valve, coupling, fitting or other component of the assembly. Furthermore, the pipe joint is permanent, and thus, the pipe must be cut away in order to detach the pipe from the valve, coupling or fitting. As a result, pipe joints and joining methods have been developed to avoid the disadvantages associated with welding, brazing and soldering pipe joints. In particular, alternative pipe joints and joining methods include mechanical “press” (also known as “crimp”) type pipe joints and mechanical “push” type pipe joints.

U.S. Pat. No. 6,805,385 B2 to Viegener issued Oct. 19, 2004, discloses a non-detachable mechanical press fit arrangement between an end portion of a metal pipe and a socket of a fitting. The socket defines an interior space for receiving the end portion of the pipe and a holding element positioned within the interior space between the outer surface of the pipe and an inner surface of the socket. The socket and the holding element are cold formed (i.e., crimped) together such that the holding element at least partially penetrates the outer surface of the metal pipe to form the pipe joint. In one embodiment, the holding element includes a compressible ring having a plurality of inwardly extending projections for engaging the outer surface of the pipe. The pipe joint and joining method taught by Viegener eliminates certain of the disadvantages of welding, brazing and soldering a pipe joint. However, the pipe joint is not detachable and requires a special crimping tool to cold form the socket and the holding element together. Thus, the arrangement is not reversible and the pipe must be cut away from the socket in order to repair or replace the pipe joint.

U.S. Pat. No. 6,499,771 B1 to Snyder, Sr. et al. issued Dec. 31, 2002, discloses a mechanical push type pipe coupling including a retainer having a plurality of outwardly extending locking teeth for engaging the inner surface of a pipe fitting and a plurality of inwardly facing locking teeth for engaging the outer surface of a pipe end. The locking teeth engage the pipe fitting and the pipe end when the pipe end is inserted into the open end of the pipe fitting, and thereby prevent relative movement between the pipe and the fitting. The pipe joint and joining method taught by Snyder, Sr. et al. avoids certain of the disadvantages of welding, brazing and soldering a pipe joint and does not require a special tool. However, the pipe joint is not detachable. Thus, the coupling is not reversible and the pipe must be cut away from the fitting or the fitting destroyed in order to repair or replace the pipe joint.

U.S. Pat. No. 4,097,074 to Nagao et al. issued Jun. 27, 1978, discloses a mechanical slip-on (i.e., push) type pipe joint construction wherein an annular sealing material is provided in a recess formed in the inner periphery of a socket of a pipe or fitting and the spigot end of another pipe is inserted into the socket. A split lock ring seated within an annular groove formed in the outer periphery of the spigot end of the pipe engages a projection on the inner periphery of the socket to prevent the spigot from being detached. Likewise, the pipe joint and joining method taught by Nagao et al. overcomes certain of the disadvantages of welding, brazing and soldering a pipe joint and does not require a special tool. However, the pipe joint still is not detachable (i.e., releasable) and the pipe must be cut away or the fitting destroyed in order to repair or replace the pipe joint.

U.S. Pat. Nos. 4,440,424 and 4,508,369 to Mode issued Apr. 3, 1984, and Apr. 2, 1985, respectively, disclose a releasable coupling device and method for coupling a tube and a fitting. The fitting has a bore for communication with a source of fluid and an opening into the bore for receiving the tube. A retaining ring positioned within the opening between the tube and the fitting has a plurality of axially extending, inwardly biased fingers adapted to engage the outer surface of the tube when the tube is inserted into the opening. An unlocking collar is provided for forcing the fingers of the retaining ring outward and thereby causing the fingers to disengage and release the tube so that the tube may be withdrawn from the opening. The coupling device and coupling method taught by Mode obviates certain of the disadvantages of welding, brazing and soldering, does not require a special tool to form the coupling, and is detachable (i.e., releasable). However, the coupling device is not capable of withstanding the higher fluid pressure typically generated within a larger diameter pipe. Thus, use of the Mode coupling device and coupling method is limited to relatively small diameter metal (e.g., aluminum, copper), plastic (e.g., polyurethane, polypropylene, polyethylene) and composite pipes.

While the known mechanical press and mechanical push type pipe joints and joining methods overcome certain of the disadvantages of welding, brazing and soldering, none provide a detachable pipe joint that does not require a special tool to form the joint and is capable of withstanding the higher fluid pressure typically generated within a larger diameter pipe. As such, what is needed is a pipe joint that is detachable and readily joins a pipe to a valve, coupling, fitting and the like without requiring a special tool to form a pipe joint capable of withstanding the higher fluid pressure typically generated within a larger diameter pipe.

### SUMMARY OF THE INVENTION

These and other objects of the present invention are achieved in the preferred embodiments disclosed below by providing a detachable pipe joint and a method of joining a pipe to a valve, coupling, fitting or the like without requiring a special tool. At the same time, the detachable pipe joint is capable of withstanding the higher fluid pressure typically generated within a larger diameter pipe. Broadly, such a pipe joint and joining method includes a retainer body defining a passageway for receiving a pipe, a retainer nut defining a through passageway coaxial with the passageway of the retainer body and the pipe, and a retaining ring positioned within an open end of the retainer body between the retainer body and the pipe. The retainer nut engages the retainer body to compress the retaining ring in a radial direction when the retainer nut is advanced in an axial direction towards the retainer body. The retaining ring has at least one, and preferably a plurality, of inwardly extending projections to retain the pipe within the pipe joint. In a preferred embodiment, the retainer body and the retainer nut are provided with complimentary threads and the retainer nut is provided with at least one flat on an outer surface so that the retainer nut can be threaded onto the retainer body without requiring a special tool and the pipe joint is capable of withstanding the higher fluid pressure typically generated within a larger diameter pipe.

In an exemplary preferred embodiment of the present invention, a detachable pipe joint includes a retainer body defining a passageway and having a first end and an open second end opposite the first end for receiving a pipe. The pipe joint further includes a retainer nut defining a through passageway coaxial with the passageway of the retainer body for receiving the pipe therethrough and a first end for engaging the second end of the retainer body. The pipe joint further includes a retaining ring positioned within the second end of the retainer body adjacent the first end of the retainer nut. The retaining ring is compressed in a radial direction to retain the pipe when the retainer nut is advanced in an axial direction towards the retainer body. The retaining ring has a first end for engaging an inner surface of the retainer body and a second end opposite the first end for engaging the first end of the retainer nut when the retainer nut is advanced in the axial direction towards the retainer body. The inner surface of the retainer body defines an inner diameter that increases in the direction of the second end of the retainer body and the retaining ring is positioned between the inner surface of the retainer body and an outer surface of the pipe. The retaining ring has at least one projection extending inwardly in the radial direction for gripping an outer surface of the pipe. Preferably, the retaining ring is generally annular and has a circumferential opening such that the retaining ring is compressible in both the radial direction and a circumferential direction. Preferably, the retaining ring has a plurality of teeth disposed on the first end and spaced apart in the circumferential direction such that the teeth grip the outer surface of the pipe when the retaining ring is compressed in the radial direction.

In another exemplary preferred embodiment of the present invention, a detachable pipe joint for joining a pipe to a fluid flow device includes a retainer body defining a passageway in fluid communication with the fluid flow device. The retainer body has a first end and an open second end opposite the first end for receiving a free end of the pipe. The retainer body further has an outer surface and an inner surface opposite the outer surface defining a ramp portion. The pipe joint further includes a retainer nut defining a through passageway coaxial with the passageway of the retainer body for receiving the pipe therethrough and a first end for engaging the second end of the retainer body. The pipe joint further includes a retaining ring positioned between the ramp portion of the inner surface of the retainer body and an outer surface of the pipe. The retaining ring is compressed in a radial direction to retain the pipe when the retainer nut engages the retainer body. The retaining ring has a first end adjacent the ramp portion of the retainer body and a second end adjacent the first end of the retainer nut. The ramp portion of the retainer body forms an angle relative to an axial direction defined by the pipe and the retaining ring includes a ramp portion opposite the ramp portion of the retainer body that forms an angle generally equal to the angle formed by the ramp portion of the retainer body. The ramp portion of the retaining ring cooperates with the ramp portion of the retainer body to compress the retaining ring in the radial direction when the retainer nut is advanced in the axial direction towards the retainer body.

In yet another exemplary preferred embodiment of the present invention, a detachable pipe joint includes a retainer body defining a passageway and having a first end and an open second end opposite the first end for receiving a pipe. The pipe joint further includes a retainer nut defining a through passageway coaxial with the passageway of the retainer body for receiving the pipe therethrough and a first end for engaging the second end of the retainer body. The pipe joint further includes a retaining ring positioned within the second end of the retainer body adjacent the first end of the retainer nut. The retaining ring is compressed in a radial direction to retain the pipe when the retainer nut is advanced in an axial direction towards the retainer body. The retainer body includes securing means adjacent the second end of the retainer body and the retainer nut includes complimentary securing means adjacent the first end of the retainer nut. Preferably, the securing means of the retainer body and the complimentary securing means of the retainer nut are screw threads and the retainer nut is threaded onto the retainer body in an axial direction to engage the retainer body and compress the retaining ring. The retainer nut has an outer surface including at least one flat that does not require a special tool for the retainer nut to engage the retainer body.

In yet another exemplary preferred embodiment of the present invention, a method of joining a pipe to a fluid flow device includes connecting a retainer body to the fluid flow device, the retainer body having a first end in fluid communication with the fluid flow device and an open second end. The method further includes inserting a free end of the pipe into the second end of the retainer body. The method further includes positioning a retaining ring within the second end of the retainer body between an outer surface of the pipe and an inner surface of the retainer body. The method further includes advancing a retainer nut in an axial direction towards the retainer body to compress the retaining ring in a radial direction against the outer surface of the pipe. The method preferably further includes providing the retainer body with an inner surface defining a ramp portion that increases in diameter in the direction of the second end and providing the retaining ring with an outer surface defining a ramp portion that cooperates with the ramp portion of the retainer body to compress the retaining ring when the retainer nut is advanced in the axial direction. The method preferably further includes providing the retainer body with securing means and providing the retainer nut with complimentary securing means and at least one flat on an outer surface thereof that does not require a special tool for the retainer nut to engage the retainer body.

The present invention and its advantages over the prior art will become even more apparent upon reading the following detailed description and the appended claims with reference to the accompanying drawings.

### BRIEF DESCRIPTION OF THE DRAWINGS

The invention may be best understood by reference to the following detailed description taken in conjunction with the accompanying drawing figures in which:

FIG. 1A is an axial cross-section view of a preferred embodiment of a pipe joint according to the present invention for joining a pipe to a conventional valve showing the pipe joint in a detached position;

FIG. 1B is an enlarged view of a portion of the pipe joint of FIG. 1A;

FIG. 2A is an axial cross-section view of the pipe joint of FIG. 1A showing the pipe joint in an attached position;

FIG. 2B is an enlarged view of a portion of the pipe joint of FIG. 2A;

FIG. 3 is an exploded perspective view of the pipe joint of FIG. 1A and FIG. 2A;

FIG. 4A is a perspective view of a preferred embodiment of a retaining ring for a pipe joint according to the present invention showing a first end of the retaining ring;

FIG. 4B is a perspective view of the retaining ring of FIG. 4A showing a second end of the retaining ring;

FIG. 4C is a side view of the retaining ring of FIG. 4A and FIG. 4B taken in the direction indicated by the line 4C-4C in FIG. 4B;

FIG. 5 is an axial cross-section view of another preferred embodiment of a pipe joint according to the present invention; and

FIG. 6 is an axial cross-section view of yet another preferred embodiment of a pipe joint according to the present invention.

### DETAILED DESCRIPTION OF PREFERRED EMBODIMENTS

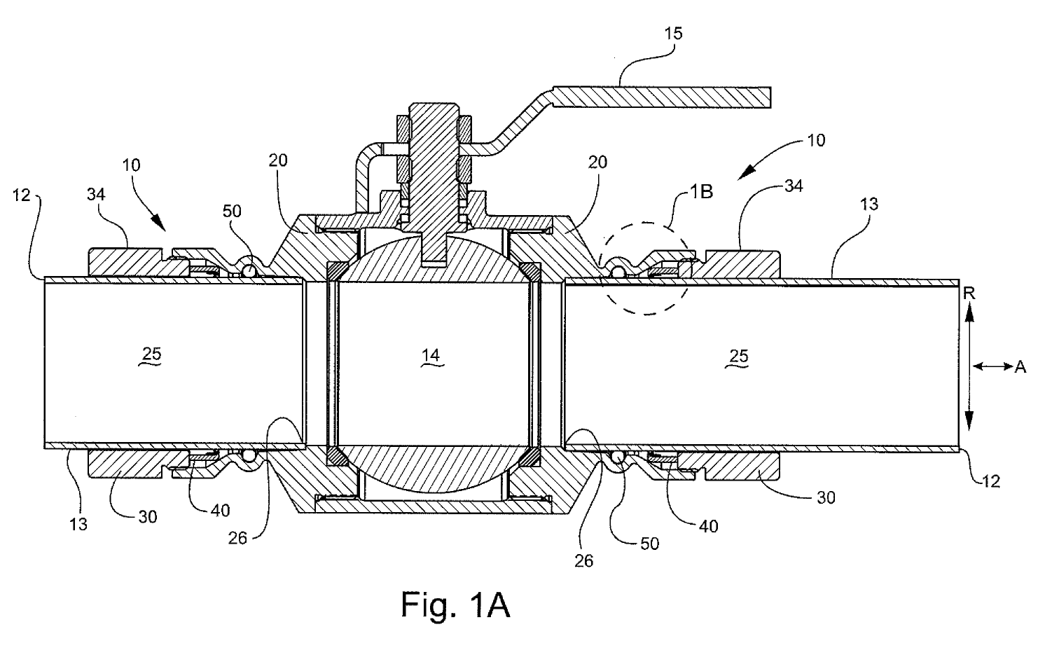

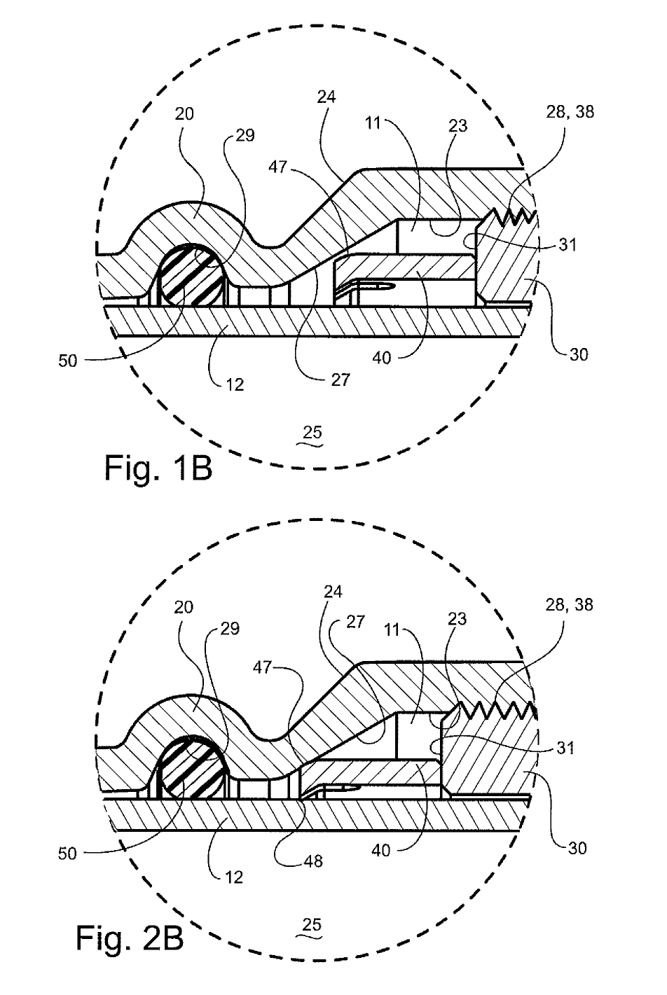

Referring now to the accompanying drawings in which identical reference numerals denote the same or similar elements throughout the various views, FIGS. 1A, 1B, 2A, 2B, and 3 illustrate a pipe joint 10 constructed in accordance with preferred embodiments of the present invention for joining a pipe 12 to a valve 14. The pipe 12 may be any conventional tube, conduit or the like defining an interior passageway for containing a fluid, the particular type and construction of which forms no part of the invention. However, as described herein, the pipe 12 is a relatively large diameter, rigid pipe, for example made of a hard metal, plastic or composite, having a tubular cross-section defining an interior passageway for conducting or transporting a liquid, such as water. It should be noted that the present invention is equally applicable to systems which handle fluids other than water, and therefore the terms “water” and “fluid” are used interchangeably herein when describing the invention. The diameter of the pipe 12 is larger than about ½ inch, and preferably is larger than about 1 inch. Typically, the outer diameter of the pipe 12 is greater than about 2 inches. However, the diameter of the pipe 12 should not be construed as limiting the intended scope of the invention in any manner.

The valve 14 may be any conventional valve, such as a flow valve, check valve, backflow preventer or the like, the particular type and construction of which forms no part of the invention. As will be described further herein, the valve 14 may also be any fluid flow device, such as a valve, coupling, fitting or the like for joining a pipe to a fluid handling device or to one or more other pipes in a known manner. As shown herein, the valve 14 is a conventional flow valve having a handle 15 for permitting, restricting or preventing the flow of fluid through the valve. Regardless, a pipe joint 10 according to the present invention provides a detachable pipe joint between a pipe and a valve, coupling, fitting or the like that does not require a special tool to form a pipe joint capable of withstanding the higher fluid pressure typically generated within a larger diameter pipe. In particular, the pipe joint 10 avoids the disadvantages, such as special equipment, acquired skill and damaging temperatures, associated with welding, brazing or soldering, and is releasable so that the pipe need not be cut away or the pipe joint destroyed in order to maintain, repair or replace the pipe, valve, coupling, fitting or other component of the assembly.

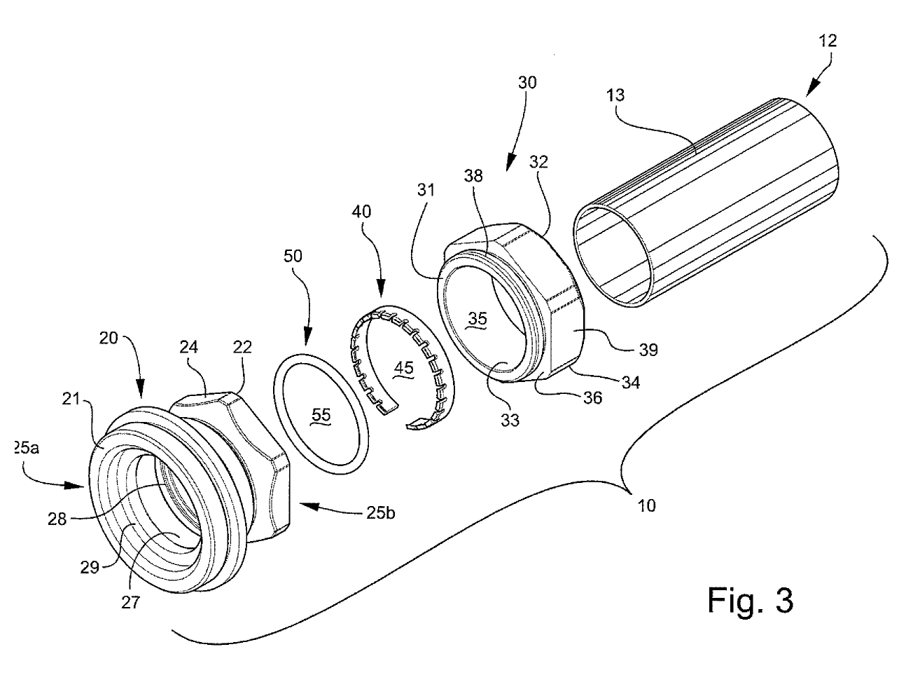

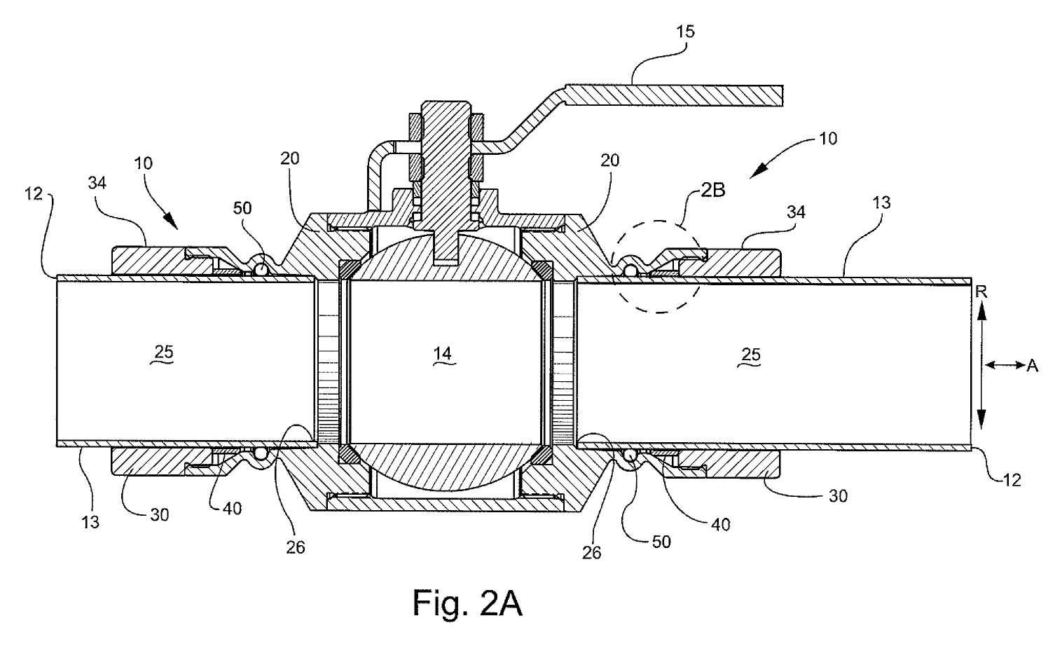

The pipe joint 10 is shown in FIG. 1A and FIG. 1B in a detached (i.e., loosened) position. Conversely, the pipe joint 10 is shown in FIG. 2A and FIG. 2B in an attached (i.e., tightened) position. In the detached position, the pipe 12 may be inserted into the valve 14, as will be described in greater detail, or removed from the valve. In the attached position, the pipe 12 is securely joined to the valve 14, as will be described herein. Regardless, the pipe 12 may be joined to the valve 14 or separated from the valve without the use of a special tool and the pipe will not detach from the valve in the attached position when subjected to a force tending to separate the pipe from the valve, such as the higher fluid pressure typically generated within a larger diameter pipe. In a broad sense, the pipe joint 10 comprises a retainer body 20, a retainer nut 30 and a retaining ring 40. The valve 14 is connected to the retainer body 20 in a suitable manner and the pipe 12 is inserted through the retainer nut 30 and into the retainer body 20 with the retaining ring 40 positioned between the outer surface 13 of the pipe 12 and the retainer body. As the retainer nut 30 is moved in an axial direction, indicated by arrow A, towards the stationary retainer body 20, the retaining ring 40 is compressed inwardly in a radial direction, indicated by arrow R. The retainer nut 30 is advanced until the retaining ring 40 contacts the outer surface 13 of the pipe 12 and exerts a retaining force sufficient to securely retain the pipe relative to the valve 14 within the pipe joint 10. The pipe 12 may be detached from the valve 14 by retracting the retainer nut 30 from the stationary retainer body 20 in the axial direction A until the retaining ring 40, which is biased outwardly in the radial direction R, releases from the outer surface 13 of the pipe. The pipe 12 may then be withdrawn from the retainer body 20 to maintain, repair or replace the valve 14 without the need to cut away the pipe 12 or destroy the pipe joint 10. The retainer nut 30 is moved (i.e., advanced and retracted) without the use of a special tool, and preferably, using a readily available tool, such as an Allen wrench, pipe wrench, vise grip, pliers or the like.

In the exemplary preferred embodiments shown and described herein, the retainer body 20 comprises a first end 21 adjacent the valve 14 and an open second end 22 opposite the first end 21 (FIG. 3). The first end 21 may also be referred to as the “inner” end with respect to the valve 14. Similarly, the second end 22 may be referred to as the “outer” end with respect to the valve 14. The retainer body 20 further comprises an inner surface 23 (FIG. 1B; FIG. 2B) and an outer surface 24 opposite the inner surface 23. A through passageway 25 extends between the first end 21 and the second end 22. The passageway 25 defines a bore 25a in fluid communication with the valve 14 adjacent the first end 21 and an opening 25b adjacent the second end 22 for receiving the pipe 12. A shoulder 26 (FIG. 1A; FIG. 2A) is formed by the bore 25a and the opening 25b to provide a mechanical stop that limits insertion of the pipe 12 into the retainer body 20, and thereby prevents the pipe from inadvertently contacting the valve 14 and obstructing operation thereof. Preferably, the pipe 12 is fully seated within the opening 25b of the retainer body 20 against the shoulder 26. The inner surface 23 of the retainer body 20 has a ramp portion 27 disposed medially between the second end 22 and the shoulder 26 that forms an angle relative to the axial direction A. The ramp portion 27 of the inner surface 23 increases in diameter in the direction of the second end 22, for a purpose to be described.

Securing means 28, for example conventional screw threads, are disposed on the inner surface 23 of the retainer body 20 between the second end 22 and the ramp portion 27. The securing means 28 cooperate with complimentary securing means 38 provided on the retainer nut 30 to attach the pipe 12 to the valve 14 by advancing the retainer nut on the retainer body 20 and to detach the pipe from the valve by retracting the retainer nut from the retainer body. The inner surface 23 of the retainer body 20 may further have a peripheral groove 29 formed therein for receiving a conventional sealing ring 50 made of an impervious, resilient sealing material, such as polyurethane or rubber. The sealing ring 50 defines a through passageway 55 for receiving the pipe 12 and is shaped to conform to the outer surface 13 of the pipe in a relatively tight, or “interference,” fit to form a fluid-tight seal therewith. As shown, the groove 29 is disposed medially between the shoulder 26 and the ramp portion 27 so as to form a fluid seal between the pipe 12 and the inner surface 23 of the retainer body 20, and thereby prevent potentially corrosive fluid from reaching the retaining ring 40 and the retainer nut 30. In the event that the securing means 28 and 38 are fluid-tight, the groove 29 alternatively may be formed in the retainer nut 30 and the sealing ring 50 disposed between the outer surface 13 of the pipe 12 and the retainer nut. The outer surface 24 of the retainer body 20 may have any desired and suitable configuration that is compatible with the valve 14 and operation thereof.

With the pipe 12 inserted within the opening 25b of the retainer body 20, a cavity 11 (FIG. 1B; FIG. 2B) is formed between the outer surface 13 of the pipe and the inner surface 23 of the retainer body. The cavity 11 extends in the axial direction A from the ramp portion 27 to the open second end 22 of the retainer body 20. The retaining ring 40 may be positioned within the cavity 11 prior to inserting the free end of the pipe 12 into the opening 25b of the retainer body 20. Alternatively, the oversized retaining ring 40 may be slid over the free end of the pipe 12 and the pipe inserted into the opening 25b of the retainer body 20 such that the retaining ring 40 is positioned within the cavity 11. The retaining ring 40 may also be formed with a mechanical hinge or with a living hinge (i.e., as a clamshell ring), and placed around the pipe 12 prior to, or after, insertion. Regardless, the retaining ring 40 is disposed within the cavity 11 through the open second end 22 of the retainer body 20 before the securing means 38 of the retainer nut 30 engages the securing means 28 of the retainer body 20. Similarly, the retainer nut 30 may be slid over the free end of the pipe 12 before the retaining ring 40, or alternatively, may be formed as a clamshell and placed around the pipe prior to, or after, insertion. Once the retaining ring 40 is positioned within the cavity 11 and the retainer nut 30 is positioned around the pipe 12, the securing means 38 of the retainer nut is engaged with the securing means 28 of the retainer body 20 to form the pipe joint 10.

In the exemplary preferred embodiments shown and described herein, the retainer nut 30 comprises a first end 31 adjacent the second end 22 of the retainer body 20 and a second end 32 opposite the first end 31 (FIG. 3). The first end 31 may also be referred to as the “inner” end with respect to the valve 14. Similarly, the second end 32 may be referred to as the “outer” end with respect to the valve 14. The retainer nut 30 further comprises an inner surface 33 and an outer surface 34 opposite the inner surface 33. A through passageway 35 extends between the first end 31 and the second end 32. The passageway 35 defines an opening for receiving the pipe 12. A shoulder 36 is formed on the outer surface 34 to provide a mechanical stop that limits insertion of the retainer nut 30 into the opening 25b at the second end 22 of the retainer body 20, and thereby prevents the retainer nut from inadvertently distorting (e.g., crushing or bowing) the retaining ring 40 and potentially obstructing operation thereof. Preferably, the retainer nut 30 is fully seated within the opening 25b of the retainer body 20 when the shoulder 36 contacts the second end 22 of the retainer body 20. The inner surface 33 of the retainer nut 30 has a smooth surface and a diameter that is only slightly greater than the diameter of the outer surface 13 of the pipe 12 such that the retainer nut has a somewhat loose, or “slip,” fit therewith.

Securing means 38, for example conventional screw threads, are disposed on the outer surface 34 of the retainer nut 30 adjacent the first end 31 for an axial distance sufficient to fully seat the retainer nut within the opening 25b of the retainer body 20. The securing means 38 cooperate with the complimentary securing means 28 provided on the inner surface 23 of the retainer body 20 to attach the pipe 12 to the valve 14 and to detach the pipe from the valve byway of the pipe joint 10. It will be readily apparent to one of ordinary skill in the art that the locations of the complimentary threads 28, 38 may be reversed. The remaining portion of the outer surface 34 of the retainer nut 30 may have any desired and suitable configuration that is compatible with operation of the pipe joint 10, and that does not require a special tool to engage the securing means 38 with the securing means 28 of the retainer body 20. Preferably, however, the outer surface 34 of the retainer nut 30 is provided with flats 39 so that the securing means 38 of the retainer nut can be engaged with the securing means 28 of the retainer body 20 using a readily available tool, such as a wrench, pipe wrench, vise grip, pliers or the like.

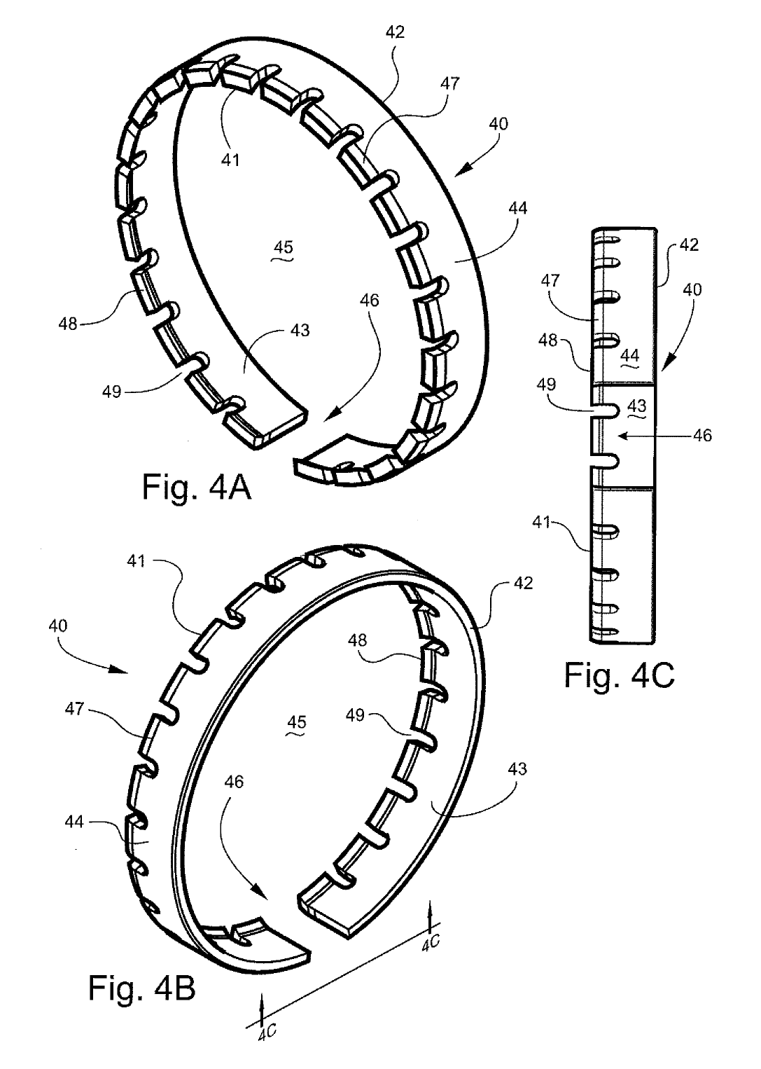

An exemplary preferred embodiment of a retaining ring 40 constructed in accordance with the present invention is shown in FIGS. 4A, 4B and 4C. As shown, the retaining ring 40 comprises a first end 41 that is disposed adjacent the ramp portion 27 of the retainer body 20 when the retaining ring is inserted within the open second end 22 of the retainer body and positioned within the cavity 11. The retaining ring 40 further comprises a second end 42 opposite the first end 41 that is disposed adjacent the first end 31 of the retainer nut 30 when the securing means 38 of the retainer nut engage the securing means 28 of the retainer body 20 (FIG. 2B). The first end 41 may also be referred to as the “inner” end with respect to the valve 14. Similarly, the second end 42 may be referred to as the “outer” end with respect to the valve 14. The retaining ring 40 further comprises an inner surface 43 and an outer surface 44 opposite the inner surface 43. A through passageway 45 extends between the first end 41 and the second end 42. The passageway 45 defines an opening for receiving the pipe 12 in a loose, or “slip,” fit. Preferably, the retaining ring 40 is oversized relative to the pipe 12 and has a circumferential opening 46 such that the retaining ring is “split” and the inherent hoop stress biases the retaining ring outwardly in the radial direction R. As best shown in FIG. 1B and FIG. 2B, the outer surface 44 of the retaining ring 40 opposite the inner surface 23 of the retainer body 20 is provided with a ramp portion 47 that forms an angle relative to the axial direction A generally equal to the angle formed by the ramp portion 27 of the retainer body. As will be readily appreciated, the ramp portion 47 of the retaining ring 40 cooperates with the ramp portion 27 of the retainer body 20 to compress the retaining ring 40 inwardly in the radial direction R when the securing means 38 of the retainer nut 30 engages the securing means 28 of the retainer body.

As shown and described herein, the retaining ring 40 comprises a plurality of projections 48 disposed circumferentially around the first end 41 between stress relief cutouts 49. The projections 48 define a plurality of sharp edges around the first end 41 on the inner surface 43 of the retaining ring 40 that function like teeth to grip the outer surface 13 of the pipe 12 when the retaining ring is compressed in the radial direction R. The location of the projections 48 on the first end 41 of the retaining ring 40 is advantageous since the compressing force is applied to the retaining ring along the contact surface between the complimentary ramp portions 27, 47. Furthermore, the location of the projections 48 on the first end 41 of the retaining ring 40 serves to counteract the forces tending to separate the pipe 12 from the valve 14. Alternatively, the projections 48 may be provided on the second end 42 of the retaining ring 40 or the orientation of the retaining ring may be reversed within the cavity 11. Similarly, it is well within the ordinary skill in the art to provide the ramp portion 27 on the inner surface 33 of the retainer nut 30 and to reverse the orientation of the retaining ring 40 within the cavity 11. However, the retaining force generated by the projections 48 gripping the outer surface 13 of the pipe 12 would likely be reduced or otherwise adversely affected in these alternative configurations. Regardless, there may be instances or situations in which such alternative configurations may prove desirable or may provide other advantages.

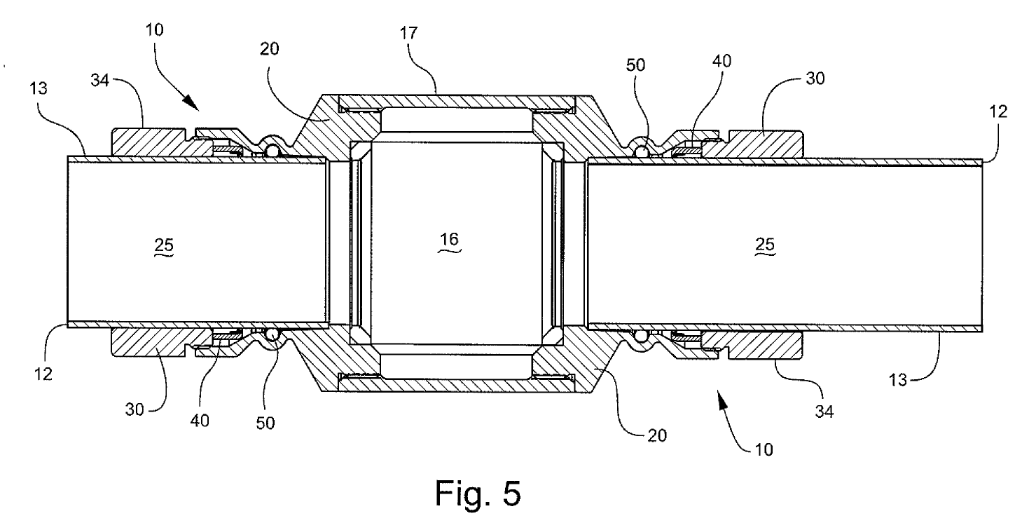

FIG. 5 illustrates another exemplary preferred embodiment of a pipe joint 10 according to the present invention. In this embodiment, the pipe joint 10 is connected to a conventional coupling 16 for joining a pair of opposed pipes 12 in fluid communication with each other and the coupling. A pipe joint 10 joins each pipe 12 to the coupling 16 utilizing a retainer body 20, a retainer nut 30, a retaining ring 40 and a sealing ring 50 in the manner previously described. The pipe joint 10 is structurally and functionally the same as, or at least substantially similar to, the pipe joint shown and described herein with respect to valve 14, and as such, will not be described further. As previously mentioned, the pipe joint 10 is detachable so that each pipe 12 can be detached from the coupling 16 without the pipe having to be being cut away or the coupling destroyed in order to maintain, repair or replace the pipe, the coupling or the pipe joint. In addition, the coupling 16 may be provided with at least one removable access plate 17 for providing access to the interior of the coupling for cleaning, sampling, testing or other purpose.

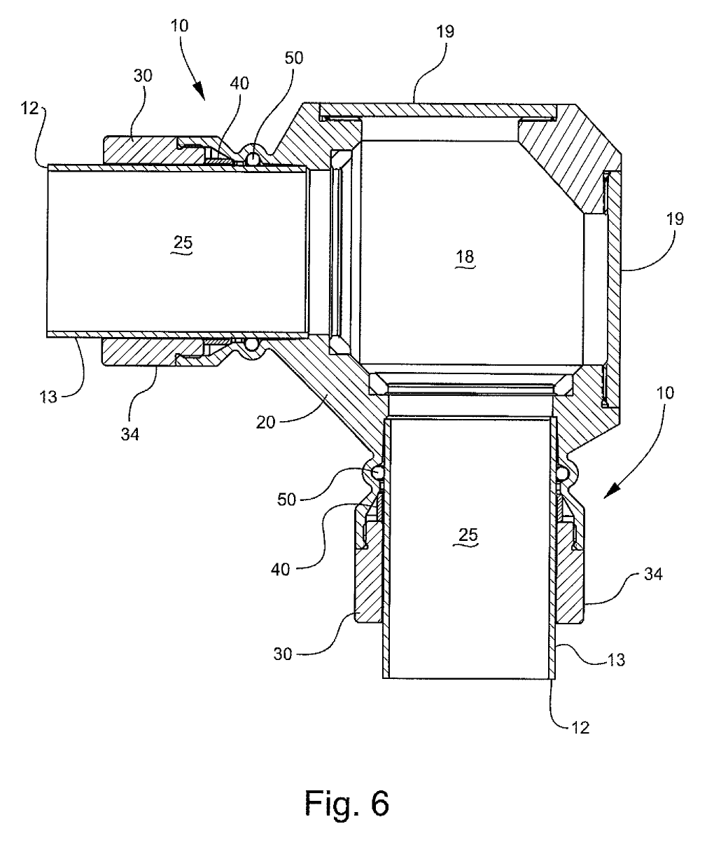

FIG. 6 illustrates yet another exemplary preferred embodiment of a pipe joint 10 according to the present invention. In this embodiment, the pipe joint 10 is connected to a conventional elbow fitting 18 for joining a pair of pipes 12 at a predetermined angle relative to one another in fluid communication with each other and the fitting. As shown, the angular orientation of the pipes 12 is ninety degrees (90°); however, the fitting 18 may join the pipes 12 at any desired angle. A pipe joint 10 joins each pipe 12 to the coupling 16 utilizing a retainer body 20, a retainer nut 30, a retaining ring 40 and a sealing ring 50 in the manner previously described. The pipe joint 10 is structurally and functionally the same as, or at least substantially similar to, the pipe joint shown and described herein with respect to valve 14, and as such, will not be described further. As previously mentioned, the pipe joint 10 is detachable so that each pipe 12 can be detached from the fitting 18 without the pipe having to be being cut away or the fitting destroyed in order to maintain, repair or replace the pipe the fitting or the pipe joint. In addition, the fitting 18 may be provided with at least one removable access plate 19 for providing access to the interior of the fitting for cleaning, sampling, testing or other purpose.

The foregoing has described a detachable pipe joint and a method of joining a pipe to a valve, coupling, fitting or the like. While specific embodiments of the present invention have been described, it will be apparent to those skilled in the art that various modifications thereto can be made without departing from the spirit and scope of the invention. Accordingly, the foregoing description of exemplary preferred embodiments of the invention and the best mode for practicing the invention are provided to enable one of ordinary skill in the art to readily make, use and practice the invention without undue experimentation. The foregoing description and depiction of preferred embodiments is provided for the purpose of illustration only, and not for the purpose of limitation, the invention instead being broadly defined by the appended claims.

What is claimed is:

1. A detachable pipe joint, comprising:
a retainer body defining a passageway and having a first end and an open second end opposite the first end for receiving a pipe;
a retainer nut defining a through passageway coaxial with the passageway of the retainer body for receiving the pipe therethrough, the retainer nut having a first end for engaging the second end of the retainer body; and
a retaining ring positioned within the second end of the retainer body adjacent the first end of the retainer nut, the retaining ring being compressed in a radial direction to retain the pipe when the retainer nut is advanced in an axial direction towards the retainer body.

2. The pipe joint of claim 1 wherein the retaining ring has a first end for engaging an inner surface of the retainer body and a second end opposite the first end for engaging the first end of the retainer nut when the retainer nut is advanced in the axial direction towards the retainer body.

3. The pipe joint of claim 2 wherein the inner surface of the retainer body defines an inner diameter that increases in the direction of the second end of the retainer body and wherein the retaining ring is positioned between the inner surface of the retainer body and an outer surface of the pipe.

4. The pipe joint of claim 2 wherein the retaining ring has at least one projection extending inwardly in the radial direction for gripping an outer surface of the pipe.

5. The pipe joint of claim 2 wherein the retaining ring is generally annular and has a circumferential opening such that the retaining ring is compressible in both the radial direction and a circumferential direction.

6. The pipe joint of claim 5 wherein the retaining ring comprises a plurality of teeth disposed on the first end of the retaining ring and spaced apart in the circumferential direction and wherein the teeth grip the outer surface of the pipe when the retaining ring is compressed in the radial direction.

7. The pipe joint of claim 2 wherein the inner surface of the retainer body comprises a ramp portion that forms an angle relative to the axial direction and the retaining ring has an outer surface opposite the inner surface of the retainer body comprising a ramp portion that forms an angle relative to the axial direction generally equal to the angle formed by the ramp portion of the retainer body.

8. The pipe joint of claim 6 wherein the ramp portion of the retaining ring cooperates with the ramp portion of the retainer body to compress the retaining ring in the radial direction when the retainer nut is advanced in the axial direction towards the retainer body.

9. The pipe joint of claim 1 wherein the retainer body comprises securing means adjacent the second end of the retainer body and the retainer nut comprises complimentary securing means adjacent the first end of the retainer nut.

10. The pipe joint of claim 8 wherein the securing means of the retainer body and the complimentary securing means of the retainer nut each comprise screw threads.

11. A detachable pipe joint for joining a pipe to a fluid flow device, the pipe joint comprising:
a retainer body defining a passageway in fluid communication with the fluid flow device, the retainer body having a first end and an open second end opposite the first end for receiving a free end of the pipe, the retainer body further having an outer surface and an inner surface comprising a ramp portion;
a retainer nut defining a through passageway coaxial with the passageway of the retainer body for receiving the pipe therethrough, the retainer nut having a first end for engaging the second end of the retainer body; and
a retaining ring positioned between the ramp portion of the inner surface of the retainer body and an outer surface of the pipe, the retaining ring being compressed in a radial direction to retain the pipe when the retainer nut engages the retainer body.

12. The pipe joint of claim 11 wherein the retaining ring comprises a first end adjacent the ramp portion of the retainer body and a second end adjacent the first end of the retainer nut and wherein the retainer nut is advanced in an axial direction to engage the retainer body.

13. The pipe joint of claim 12 wherein the ramp portion of the retainer body forms an angle relative to the axial direction and the retaining ring comprises a ramp portion opposite the ramp portion of the retainer body that forms an angle generally equal to the angle formed by the ramp portion of the retainer body.

14. The pipe joint of claim 13 wherein the ramp portion of the retaining ring cooperates with the ramp portion of the retainer body to compress the retaining ring in the radial direction when the retainer nut is advanced in the axial direction towards the retainer body.

15. The pipe joint of claim 11 wherein the retainer body comprises screw threads adjacent the second end of the retainer body and the retainer nut comprises complimentary screw threads adjacent the first end of the retainer nut and wherein the retainer nut is threaded onto the retainer body in an axial direction to engage the retainer body and compress the retaining ring.

16. The pipe joint of claim 11 wherein the retaining ring is generally annular and has a circumferential opening such that the retaining ring is compressible in both the radial direction and a circumferential direction and wherein the retaining ring comprises at least one projection extending inwardly to grip the outer surface of the pipe when the retaining ring is compressed in the radial direction.

17. The pipe joint of claim 11 wherein the retainer nut has an outer surface comprising at least one flat that does not require a special tool for the retainer nut to engage the retainer body.

18. A method of joining a pipe to a fluid flow device, the method comprising:
connecting a retainer body to the fluid flow device, the retainer body comprising a first end in fluid communication with the fluid flow device and an open second end;
inserting a free end of the pipe into the second end of the retainer body;
positioning a retaining ring within the second end of the retainer body between an outer surface of the pipe and an inner surface of the retainer body; and
advancing a retainer nut in an axial direction towards the retainer body to compress the retaining ring in a radial direction against the outer surface of the pipe.

19. The method of claim 18 further comprising providing the retainer body with an inner surface comprising a ramp portion that increases in diameter in the direction of the second end and providing the retaining ring with an outer surface comprising a ramp portion that cooperates with the ramp portion of the retainer body to compress the retaining ring when the retainer nut is advanced.

20. The method of claim 18 further comprising providing the retainer body with securing means and providing the retainer nut with complimentary securing means and at least one flat on an outer surface thereof that does not require a special tool for the retainer nut to engage the retainer body.
